(19) United States
(12) Patent Application Publication
(10) Pub. No.: US 2020/0065947 A1
(43) Pub. Date: Feb. 27, 2020

(54) ADAPTIVE EXPOSURE CONTROL SYSTEM, FOR HIGH DYNAMIC RANGE SENSING OF PHENOMENA HAVING EXTREME VARIATION IN SIGNAL LEVEL

(71) Applicants: Ryan E. JANZEN, Kingsville (CA); Steve W. MANN, Toronto (CA)

(72) Inventors: Ryan E. JANZEN, Kingsville (CA); Steve W. MANN, Toronto (CA)

(21) Appl. No.: 16/467,954

(22) PCT Filed: Dec. 11, 2017
(86) PCT No.: PCT/CA2017/051497

§ 371 Date: Jun. 8, 2019

Related U.S. Application Data
(60) Provisional application No. 62/497,963, filed on Dec. 9, 2016.

(51) Int. Cl. G06T 5/00; G01J 1/42; G01D 3/032; G01J 1/04

(52) U.S. Cl. CPC G06T 5/007; G01J 1/4214; G01J 2001/4406; G01J 1/4228; G01J 1/0437; G01D 3/032

(57) ABSTRACT

Disclosed is a system for combining multiple signals or sensor measurements, representing the same physical phenomenon, into a consolidated signal or measurement describing the given physical phenomenon more accurately or precisely, the system comprising a control system to automatically set or adjust the gain of the multiple signals or measurements, and a merging subsystem. The primary application is as an adaptive High Dynamic Range (HDR) sensing system. Disclosed are systems based on it. Such as for the viewing of electric are welding or other phenomena having extreme variation in exposure or signal level. In some embodiments the system includes a machine learning module that adapts to scene or subject matter changes, temporarily, spatially, or spatiotemporally. Coupled dynamic dynamic-range (D²R) compositing operates by assembling sensor information, such as images or audio, from multiple “strong”” and “weak” exposures that are allowed to move and change over time, as lighting conditions or sound conditions change over time in their amplitude-domain properties. A feed back-control method automatically adjusts multiple exposure value settings for HDR compositing. To increase the dynamic range of a sensory process, such as video capture. The system is designed to asymptotically approach an optimal distribution of camera exposure control settings, under varying lighting conditions and motion, to capture an extremely high dynamic range for HDR compositing. This exposure array control system is designed to improve the effective dynamic range of cameras, audio recorders, and other sensors. Applications include an audio recorder that can be taken out of one's pocket, and used to record an earthquake or a ballistics test, and then the whispers of a mouse in a quiet room all without adjusting any volume or gain adjustments, and using ordinary sensors and ordinary analog-to-digital converters (ADC's) with a limited inherent dynamic range. Welding vision systems, autonomous robot and spacecraft vision systems, acoustic recorders in geology/mining, and scientific cameras and signal recorders, are all particular applications of this system, requiring extreme dynamic ranges with unpredictable, nonstationary signals. We have devised a new method for automatic exposure-setting” control, to enable coupled dynamic dynamic-range (CD²R) video compositing. Rather than an HDR system that needs to be tuned for each lighting scenario (e.g. indoors with two exposures, and then returned outdoors with three exposures when viewing the sun or welding). The feedback control system adapts to the dynamic histogram of each exposure image to control all the exposure settings in tandem. The dynamic-range is “covered” by a set of exposures which are moving over time, in response to varying conditions of the original signal.

### FIELD OF THE INVENTION

The present invention pertains generally to an adaptive HDR (High Dynamic Range) sensing apparatus to help people, machines, processes, or computers to sense physical quantities such as light (facilitating images, video, human vision, or the like), sound (facilitating audio, human hearing, or the like), vibrations, electromagnetic radiation, or other sensed quantities, in situations where there is extreme variation in those quantities.

### BACKGROUND OF THE INVENTION

Sensors such as cameras, microphones, seismic sensors (geophones), water sensors (hydrophones), electric sensors (ionophones), force transducers, pressure sensors, flow sensors, etc., have a certain range over which they can sense reliably. The ratio of 20 the largest magnitude signal that can be sensed accurately, to the magnitude of the smallest signal that can be sensed at all, is called the dynamic range.

All sensors have a limited dynamic range. Whether in an acoustic sensor, thermometer, or camera, a physical phenomenon is sensed only as weakly as a certain minimum perceptible difference, up to a maximum amplitude or intensity.

Digital sensors have a further limitation—quantization—where signals can only be expressed by a limited set of discrete numbers. As a result, signals can only be sensed over a limited dynamic range.

The dynamic range of a sensory process can be improved using high dynamic range (HDR) compositing, where one physical phenomenon is simultaneously sensed 30 multiple times. In dynamic range compositing, multiple exposures (e.g. images or audio samplings, etc.) of a physical phenomenon can be taken at different exposure settings, either using a single sensor that switches between gain settings in a sequence, or using an array of differently-configured sensors.

Finally the data is composited into an output that covers a wider dynamic range than that of one single capture of the signal. In this way, it is possible to overcome the limited dynamic range of a camera, audio recorder, or other sensor.

Most sensors can withstand, without damage, a greater signal level than they can accurately measure. Cameras, for example, often saturate and produce images that are completely white, at light levels that don't permanently damage them. The ratio of the largest magnitude signal that can be withstood without damage, to the magnitude of the smallest signal that can be sensed at all, is called the “dynamage range”. HDR sensing helps to close the gap between dynamic range and dynamage range, i.e. extending the former toward the latter.

### SUMMARY OF THE INVENTION

The following briefly describes the new invention.

The present invention is an adaptive HDR (High Dynamic Range) sensing system in which there are either multiple differently gained gettings from at least one sensor, gettings from at least one sensor operating at or with various sensitivity, amplification, or attenuation characteristics, multiple sensors of differing sensitivity, or a combination of these three methods.

For example, in one embodiment, the gain of a sensor is adjusted adaptively to capture physical phenomena according to the amplitude(s) or dynamic range of the phenomena. In another embodiment, a dynamically-varying selection of (or number of) sensor readings are captured at different gain levels, in order to match the available dynamic ranges of each with the dynamic range of the physical phenomena which are being captured. A further embodiment combines the above two methods, by adaptively adjusting the number (or selection) of sensor readings to capture, and also adaptively controlling one or more of the gains corresponding to those sensor readings. That is, the system automatically generates a Wyckoff set, by computing the optimal number of elements of the Wyckoff set, as well as the gains of one or more members of the set.

In another embodiment, an amplifier or attenuator, or both, are selectively modified or switched, varying the signal level reaching the sensor's input. In one example for a camera system, an array or gradation of various neutral density filters are mounted on a spinning disk, filtering light at varying attenuations before it enters the camera, in synchronization with video captured by the camera. More generally, an amplifying or attenuating array or gradation can be switched between, moved or controlled by an actuator or an electronic signal.

In some embodiments this is done in conjunction with sensor gain changes. For example, an adaptive scene analysis and machine learning algorithm determines that a camera scene requires a dynamic range of 300,000,000 to one, and the frame rate is 120 frames per second, so the longest exposure is made at 1/120th of a second, using the highest available gain (e.g. highest “ASA” or “ISO” setting) with no filter attenuation, and then a next exposure is made at 120th of a second with lowest gain, and then a shorter exposure is made, and finally the shortest exposure is captured using the lowest gain at the exact instant when a dark filter is in front of the camera, while it is spinning around in genlock synchronization with the camera.

In other embodiments a beam splitter is used with two cameras so that two gettings can be made at the same time. The beam splitter is designed such that most of the light energy is reflected off its front to one camera, while a small amount is transmitted through to the other camera, thus providing two captures with very different attenuations of the original light. The beam splitter in some embodiments is adaptive, whereas in others it is fixed while only the gains and exposure times of the cameras are adaptive, and the number of exposures in each Wyckoff set in this example is even, i.e. images are captured in simultaneous pairs. If the dynamic range of the visual subject matter is moderate, only one pair is needed, and there are no motion artefacts. If the required dynamic range evolves to being more extreme, the system adapts to capturing two pairs or more pairs of exposures, while the interval between the exposures also adapts.

In other embodiments, electronic beam splitters, filters, spatial light modulators, and the like, are used to further the adaptive nature of the system. In a simple case, a controllable light filter such as a liquid crystal light attenuator is controlled electronically, switching between different attenuations corresponding to a sequence of image or frame captures. In a further embodiment, an SLM (Spatial Light Modulator) in front of an image capture sensor uses a varying pattern of attenuation that is scene or subject-matter adaptive, attenuating the image in certain areas more than others. In this way, some regions of the scene are captured with exposures that are further apart, whereas other areas of the scene are captured with exposures that are closer together. In the case of electric arc welding, for example, regions of the image where there is high contrast are captured in a Wyckoff set that has greater spacing between the exposures, whereas regions of lower contrast are captured with more overlap between exposures. Areas of the image having low contrast are captured using just one single exposure, so there is no motion artefact in these regions. The result is an image that captures all areas of the image in an optimal way, e.g. in an image with human subjects, the faces are all depicted naturally, while at the same time the dazzle of bright lights in the scene is captured well and exposed properly.

The invention is also applicable to acoustics, audio sensing, seismology, structural dynamics or the sensing of any other waves or vibrations. Signals are sensed by transducer(s) such as one or more microphones, hydrophones, geophones, or other sensors. In these embodiments, the signal level can be controlled or varied with attenuators on one or more transducers, and/or controllable-gain transducers, and/or a set of different amplification or attenuation circuits affecting the output of one or more transducers, and/or controllable gain stages at the input of a set of different analog-to-digital converters (ADCs).

In this invention disclosure, we present control systems that vary a generalized “exposure setting”. This terminology allows us to speak more generally about the control of sensing processes, irrespective of the modality of the physical phenomenon being sensed.

In a camera, for example, the “exposure setting” controls one or more of the following camera settings:
exposure speed;
aperture size (F-stop);
sensor sensitivity (commonly called “ISO”);
SLM (spatial light modulator) attenuation, or attenuation by any other form of controllable attenuator; and
any other control input that affects the dynamic range or dynamic level of sensitivity.

For other embodiments where different physical phenomena are sensed, such as audio, vibration, temperature, pressure, etc., the “exposure setting” can control one or more of the following:
an amplifier or attenuator, affecting the amount of a physical phenomenon delivered to a sensor before it is captured by the sensor;
gain value or sensitivity of the sensor itself;
gain value or other transformation of a signal operation on the sensor's output signal;
any other control input that affects the dynamic range or dynamic level of sensitivity.

In the case where the exposure setting is a linear gain value, χₑ=gₑ, the dynamic ranges of the exposures are internally re-aligned by a factor of 1/gₑ.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 illustrates example embodiments of multi-exposure sensing apparatus, equipped with the feedback-based exposure control.

FIG. 2 illustrates circuit configurations of a sensor transducer and signal conditioning, by way of example, which provide exposure control capability as part of the invention.

FIG. 3 illustrates a feedback-based HDR sensing system, means, or apparatus, in subfigures (C) and (D), in comparison to an automatic gain control sensing system (A), and to a static-exposure HDR sensing system (B).

FIG. 4 illustrates an embodiment of the invention with a lattice network to control the HDR exposures.

FIG. 5 illustrates an embodiment of the invention with a saliency control system to reduce the computational load.

FIG. 6 illustrates examples of saliency segmentation of an image.

FIG. 7 illustrates a physical analogy for coupled motion of the exposure controllers, with a forcing function between each of the exposures.

FIG. 8 illustrates a mass-spring analogy for system behaviour.

FIG. 9 illustrates an example of HDR compositing function of a time-varying signal.

FIG. 10 illustrates an amplitude-frequency segmenting control subsystem.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of the appended claims.

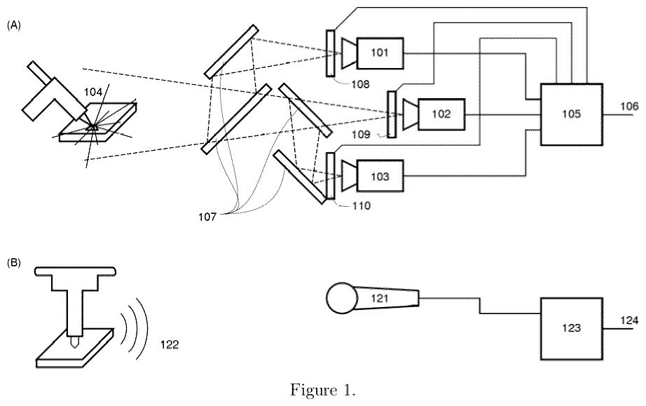

FIG. 1 Illustrates example embodiments of the invention, with a multi-exposure sensing apparatus equipped with feedback-based exposure control. (A) Illustrates a video or image capture system with three cameras 101, 102 and 103. In this example, the system has been placed in front of an arc welding operation 104 which produces a very wide dynamic range of light: extremely bright near the welding tip, and relatively dark in other areas. Light rays are split by beam splitters 107. To provide an HDR video feed to allow recording and/or human monitoring of the visual scene, the camera outputs are connected to a signal processing unit 105, which is designed for intelligent control of the camera exposures. The processor 105 can be built to control the cameras directly, or, as illustrated, can be connected to variable-opacity controllable liquid crystal glass plates (108, 109, 110), for example. The processor controls 108 for a dark exposure in camera 101 such that it accurately captures the brightest zones in the image within its dynamic range. Similarly, 109 and 102 capture a medium exposure. Finally, the processor controls 110 for a bright exposure in camera 103 such that it accurately captures the darkest zones in the image within its dynamic range. In preferred embodiments, 105 controls all three exposures independently in order to increase the dynamic range that can be captured, and/or to increase the accuracy of the captured signal given the physical light at any particular time, and given the dynamic range and linear or nonlinear response functions of the cameras. The camera signals can be optionally viewed or recorded separately, and/or recorded and/or composited on the processor itself into an HDR output signal 106.

Similarly, embodiments of this invention apply to other physical signals such as sound or vibrations. FIG. 1B illustrates a different embodiment consisting of an acoustic or vibration transducer 121, such as a microphone monitoring high dynamic range acoustic signals from industrial work (such as jackhammering 122) or a music performance, or a geophone monitoring building vibrations or geological activity. To overcome limited dynamic range in recording or in analog-to-digital conversion (ADC), this invention includes systems in a signal processing unit 123 to split the signal into differently-gained or differently-exposed versions of the transducer signal before recording or before ADCs. Alternatively, the invention can be built using multiple acoustic or vibration sensors 121, each with a controllable gain or with a controllable attenuator analogously to FIG. 1A.

A key limitation of high dynamic range (HDR) compositing with static exposure settings is its lack of adaptation to time-varying conditions.

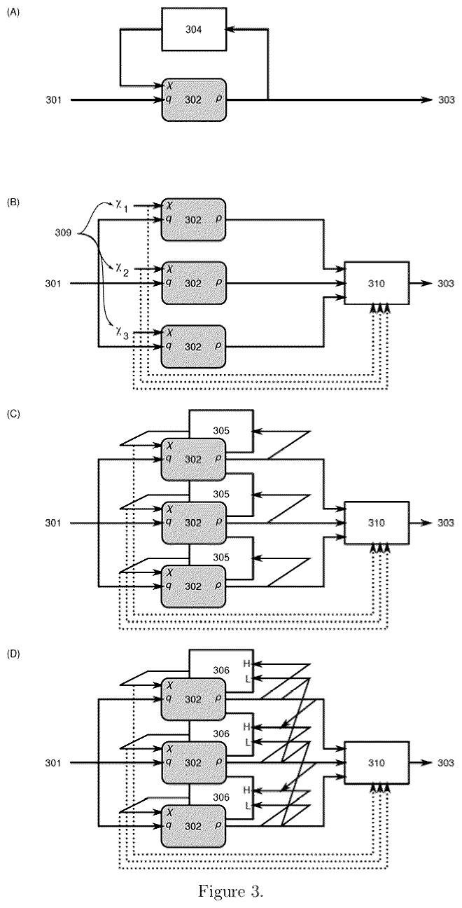

For example, an HDR video compositor system built with three static exposures might capture a complete dynamic range in an office setting, but may be woefully inadequate when brought to a welding facility with low light levels other than extremely bright light at small points where the welding is taking place. The result can be portions of an image that are all black, while the welding work is seen clearly (the case of dark exposures), or a completely white, saturated, indeterminate region where the welding takes place, and the rest of the room is visible (the case of bright exposures). This fixed-exposure HDR configuration is illustrated in FIG. 3(B).

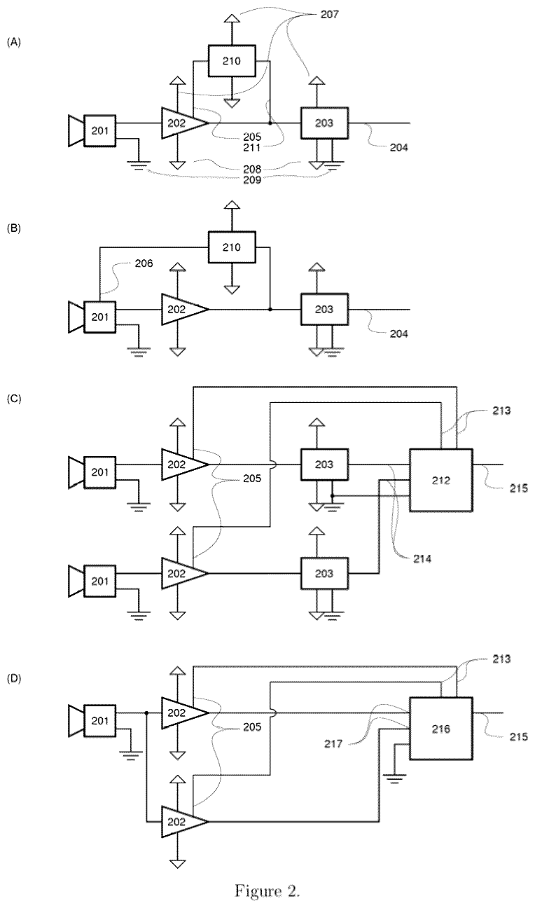

FIG. 2 Illustrates circuit configurations of a sensor transducer and signal conditioning, by way of example, in order to provide exposure control capability. In one embodiment, a sensor transducer 201, such as a microphone or light sensor, is connected into the input of an optional amplifier circuit 202, and/or an optional analog-to-digital converter (ADC) 203, all with a final output 204 to be recorded, transmitted, fed into a computer, earpiece or augmented reality system, or the like.

The exposure is adjusted through a variable gain input (or other exposure control input), such as a gain input on the amplifier 202 (as shown in FIG. 2A), or an input 206 on the sensor transducer 201 itself (as shown in FIG. 2B), or a control input on the ADC 203, or the like. For clarity, examples of power hookups are illustrated, with a positive voltage supply 207, a negative voltage supply 208, and circuit ground 209.

An exposure feedback control system can be implemented in the form of an analog circuit 204, for example. In FIG. 2, this circuit is represented in box 204 with its input on the right side (e.g. drawing on a monitor tap of the sensed signal, such as a preamplfied line 211) and its output on the left side. This control circuit, for example, can consist of a rectifier circuit, feeding into a low-pass filter circuit (thus creating an envelope detector circuit), in turn feeding into an op amp circuit configured with a decreasing input-output characteristic, such as a typical inverting amplifier op amp circuit, with DC biasing resistors selected to give the op amp circuit a DC offset according to the desired default sensor gain.

Alternatively, exposure control can be implemented on a digital processor, such as a microcontroller unit 212 with analog output(s) 213 to send out exposure control signal(s). A dynamic range compositing subsystem can also implemented on a microcontroller unit 212. FIG. 2C illustrates these systems combined, by way of example. Herein, two sensor transducers feed two controllable gain stages and ADCs, respectively. The processor 212 controls the exposures at different levels, and the resulting differently-exposed signals 214 are fed into processor 212, completing a feedback loop. Those differently-exposed signals 214 are also merged in the processor 212 using standard HDR compositing techniques, into an expanded dynamic range output signal 215.

Another embodiment makes use of one or more sensor transducers 201, each of whose outputs feed into two or more parallel channels with different exposure characteristics (such as gain, etc.).

An unrelated alternative embodiment makes use of a processor 216 which includes its own internal ADC inputs 217, and does not require external ADCs. In this case, the exposure control system is programmed with maximum and minimum gain values such that the signals feeding into processor 216 fall within 217's acceptable input levels and dynamic range.

FIG. 2D illustrates the above two embodiments together in the same implementation, for example. A single sensor transducer 201 is connected into two controllable amplifiers 202; each amplifier is controlled individually by 216 with a different gain.

Another embodiment includes spectral processing (such as filtering circuits) on each separate channel. For example, applied to FIG. 2D, a low-pass filter circuit (such as a first-order low-pass RC circuit) is inserted at the output of one amplifier, and the filter's output feeds into the corresponding input of the processor 216. A high-pass filter circuit is inserted at the output of the other amplifier, and this filter's output feeds into the other corresponding input of the processor 216.

In multi-sensor or multi-pixel embodiments such as a camera or microphone array, these circuits can be repeated in array or matrix form, in some embodiments with a multiplexer circuit to share amplifier stages 202, ADCs 203, and/or exposure controllers 210, for multiple sensor transducers 201.

In the subsequent figures (3 onward), the sensor transducer and any control and conditioning circuitry or systems acting on its individual output signal, are collectively represented as a “sensor”, having an input representing the physical phenomenon which it senses, as well as an input representing any control signal that controls its response characteristics (such as its sensitivity, mode, attenuation, gain, transfer function, frequency characteristics, or the like) as an “exposure control input”.

FIG. 3 Illustrates a context of exposure control and HDR compositing, as well as two embodiments of the invention. Subsystems are represented as signal processing units, which are implemented in either hardware or software, or both.

(A) A typical autoexposure camera or sound recorder with automatic gain control (AGC) uses a feedback control to vary the exposure or gain setting. In a general sensing system based on AGC, a physical phenomenon 301 such as light, sound, or the like, is sensed by a sensor as illustrated by 302 (which typically includes a transducer 201 to convert the phenomenon 301 at its sensing input q into a signal p, and optionally includes signal conditioning such as an amplifier circuit 202, and/or an analog-to-digital converter (ADC) 203, and/or the like), a signal output 303 which may be monitored, recorded, or fed into another system, as well as an exposure control system 304 which determines or adjusts the sensor 302's exposure control input χ to ensure the sensor's output ρ is covered within the sensor's available dynamic range as much as possible. The exposure control system 304 may be implemented as a circuit or hardware 210, and/or running on a processor 212. Disadvantages of such AGCbased systems include: a loss of information regarding the original signal strength, and a failure to capture outlier elements in array sensing (e.g. saturated image pixels).

(B) Fixed-exposure HDR compositing captures multiple exposures of the same phenomenon, using a fixed set of gains or exposures 309, to try to capture an wider dynamic range. The physical phenomenon 301 is sensed by a plurality of sensor exposures 302, either embodied as multiple sensor transducers with controllable exposures, or one single sensor transducer with parallel signal conditioning lines which are separately controllable in terms of gain or other exposure quantities. These multiple controllable exposure sensings are represented by multiple blocks 302. The captured signals are fed into a dynamic range compositor 310, which merges the information into a high dynamic range signal at the final output signal 303. Note: The exposures can be captured at the same time, or one single sensor can be cycled through the sequence of exposure settings. However, these fixed exposure settings cannot anticipate the particular subject matter in a photo, for example, where a photo of the sky might produce many pixels which lie in a suboptimal portion of the dynamic range. There is a risk of information loss if the phenomenon's signal becomes stronger or weaker than the anticipated dynamic range corresponding to the fixed exposures. There is a risk of inefficient coverage of the dynamic range by the available exposures; for example, two exposures may be closer together than necessary to capture the dynamic range mutually covered by them; or as another example, the phenomenon quantity may not occupy the dynamic levels in the middle of the combined dynamic range of the two exposures, and thus the exposures do not need to be adjacent to each other. Excessive sacrifices to sample rate or frame rate may occur due to inflexible exposure settings.

(C) Isolated Dynamic Dynamic Range (ID2R) Compositing, with feedback to control exposures. A set of exposure controllers 305 each control a different parallel sensor system, with each 305 being set up in advance to cause its respective sensor 302 to capture a different portion of the dynamic range of physical phenomenon 301. There is a dynamic exposure response to varying input signal conditions. This embodiment illustrates independent AGC units, each working separately on unconnected sensor exposures. The result is inefficient coverage of the entire dynamic range, due to uncontrolled exposure overlap.

(D) Coupled Dynamic Dynamic Range (CD2R) Compositing. A preferred embodiment of the invention consists of a coupled control system to control dynamic ranges of each exposure, through the exposure settings. In this embodiment, there are cross-linked connections for exposure control. has inputs “H” and “L” which are connected to local and neighbouring exposure signals p. The purpose is to continuously optimize the overall dynamic range coverage.

The feedback loop allows asymptotic approach of an optimum, and adaptation to time-varying sensor conditions and conditions of the physical phenomenon being sensed. For example, if a camera is being carried around through different parts of a room, the control system can adapt to the changing lighting conditions by dynamically changing exposures.

A preferred embodiment consists of joint control of the exposures, based on joint metrics of the sensors output in real-time.

In one preferred embodiment, the couplings driving each exposure are composed of at least two types, which we refer to as “L” and “H”.

An L coupling influences an exposure's settings according to uncertain or insufficientlydetermined information about the physical phenomenon occurring at weaker dynamic levels than what is sensed by the exposure, as well as uncertainty in the samplings of information within the exposure's dynamic levels, either of which would influence the exposure to shift downward to a more sensitive range.

An H coupling influences an exposure's settings according to uncertain or insufficientlydetermined information about the physical phenomenon occurring at stronger dynamic levels than what is sensed by the exposure, as well as uncertainty in the samplings of information within the exposure's dynamic levels, either of which would influence the exposure to shift upward to a less sensitive range.

In one embodiment of the above, each exposure sampling output is fed into one or more uncertainty metric analyzers, which form one or more uncertainty metrics describing the current sampling, such as a time-frame of video or a time-sample or time-frame of audio.

In one simple further embodiment, each exposure frame is assigned two metrics: infra-uncertainty and supra-uncertainty, based on the number of samples (e.g. pixels or audio samples) which occupy the top and bottom segments, respectively, of a histogram of those very samples within the exposure's dynamic range.

In a more preferred embodiment, each exposure frame is assigned two metrics: infra-uncertainty and supra-uncertainty, based on both the above histogram as well as the response function of the sensor or sensory process. For example, in one embodiment, a summation is formed over all bins of the above histogram, of a function of the population of each bin, and the inverse response function of the sensor evaluated at the sensor value corresponding to each bin. In that way, samples are penalized if they occupy a portion of the dynamic range where the sensor's output has little variation; hence leading to uncertainty in knowledge of the true value of the physical phenomenon.

In a more generalized embodiment, the samples' histogram occupancy of the dynamic range, in two or more exposure, are used along with knowledge of the sensory system's properties to control the exposure settings.

In one embodiment, the infra-uncertainty of each exposure (except for the most sensitive exposure, which senses the weakest dynamic levels), is used to control the adjacent more sensitive exposure (which senses a weaker dynamic level). The supra-uncertainty of each exposure (except for the least sensitive exposure, which senses the strongest dynamic levels), is used to control the adjacent less sensitive exposure (which senses a stronger dynamic level).

In that way, each exposure is influenced up or down in sensitivity according to a push/pull mechanism from its nearest neighbours, thus forming a chain of exposures where each is linked to the next according to its response to the actual input data.

For example, if a video sequence suddenly contains a set of pixels which are darker than previously experienced, then the most sensitive exposure is shifted down in its dynamic level, and all other exposures are also influenced down, but are counterinfluenced by their need to adequately cover their other dynamic ranges. In that way, the exposures demonstrate a shared collective goal of working together to adequately cover the dynamic range of the true input data, with sensitivity to the actual histograms of that data. For example, if one pixel in a video is poorly sampled, a large number of other pixels at a different dynamic level will outweigh the one pixel in priority, if their goals happen to conflict.

Embodiment with Lattice Uncertainty Chain:

We now describe an embodiment of the invention with a lattice progression of uncertainty metrics.

We define the sensor's response function as ƒ(q). We define an input signal received from the sensor, in response to a physical signal, q.

ρ=ƒ(q) (1)

The original physical signal, q, might be at a variety of different levels (bright v.s. dark, or loud v.s. soft), but the only observable from the sensor is its output signal, ρ.

The system controls each of the e=1 . . . E exposures, each set with parameter or set of parameters, χₑ.

In one class of embodiments, the HDR exposures are controlled such that they are allowed to overlap or separate from one another, beyond simply neatly abutting against each other in their dynamic range, where one exposure saturates exactly at the point when the next exposure barely senses a signal.

If ƒ(q) has low-precision anywhere in its dynamic range [qₘᵢₙ, qₘₐₓ], then the control system allows a greater amount of overlap with another exposure to compensate.

Precision of the sensor within its dynamic range is expressed by an uncertainty function, u(ρ), for each possible sensor output ρ. For example, if the sensor's nonlinear response function is smooth and continuous, the uncertainty function could be given as:

$$u ( ρ ) = {( \frac{\partial f}{\partial q} )}_{{f}^{- 1} ( ρ )} \qquad ( 2 )$$

In this case, the more coarsely spread is the sensor's response at a particular signal level, the less precision is available about the original phenomenon, and thus the less weighting is to be placed on that sample/pixel from that exposure, as opposed to the same pixel from other exposures. Uncertainty is thus a measure of the degree of usefulness of each sample/pixel in an HDR composite, based on the particular exposure settings.

We compute an uncertainty image Uₑ(x,y) for each exposure frame/image Iₑ(x,y), composed of the uncertainty function of each sample/pixel. We then compute a set of optimization cost functions:

Supra-uncertainty, a cost function expressing a penalty on near-saturation, strong samples/pixels in each exposure. It influences the exposure, forcing it down to a lower amplification.

$${u}_{H , e} = {\sum }_{x , y} \frac{{I}_{e} ( x , y ) - {ρ}_{min}}{{ρ}_{max} - {ρ}_{min}} \cdot {( \frac{\partial f}{\partial q} )}_{{f}^{- 1} ( {I}_{e} ( x , y ) )} \qquad ( 3 )$$

Infra-uncertainty, a penalty on weak signals near cutoff:

$${u}_{L , e} = {\sum }_{x , y} \frac{{ρ}_{max} - {I}_{e} ( x , y )}{{ρ}_{max} - {ρ}_{min}} \cdot {( \frac{\partial f}{\partial q} )}_{{f}^{- 1} ( {I}_{e} ( x , y ) )} \qquad ( 4 )$$

Cross-uncertainty a penalty or cost function, expressing a joint uncertainty caused by two adjacent exposures:

$${u}_{C , e} ( {I}_{e} , {I}_{e + 1} ) = {\sum }_{x , y} min ( {U}_{L , e} ( x , y ) , {U}_{H , e + 1} ( x , y ) ) \qquad ( 5 )$$

As an intermediate step, the per-pixel uncertainty images are:
U_{H,e}(Iₑ) supra-uncertainty image (penalty array expressing pixels whose uncertainty is caused by saturated signals)
U_{L,e} (Iₑ) infra-uncertainty image (penalty array expressing pixels whose uncertainty is caused by cutoff, weak signals)
U_{C,e}(Iₑ,Iₑ₊₁) cross-uncertainty image (penalty array expressing pixels with a joint uncertainty caused by two adjacent exposures)

We control each of the exposure settings, χₑ, for the e^{th} exposure. The feedback loop is completed with the sensor capture Iₑ(χₑ,t) for each exposure, resulting from those exposure settings.

The control system is governed by two counterveilling influences. Each exposure setting is influenced by a push-pull mechanism from both ends of the dynamic range of each exposure. This signal is expressed as Δu, accounting for the difference in uncertainties between successive exposures.

$$Δ {u}_{e} = \{ \begin{matrix}{u}_{C , e} ( {I}_{e} , {I}_{e + 1} ) - {u}_{H , e} ( {I}_{e} ) , & for e = 1 \\ {u}_{C , e} ( {I}_{e} , {I}_{e + 1} ) - {u}_{C , e - 1} ( {I}_{e - 1} , {I}_{e} ) , & for 1 < e < E \\ {u}_{L , e} ( {I}_{e} ) - {u}_{C , e - 1} ( {I}_{e - 1} , {I}_{e} ) , & for e = E\end{matrix} \} \qquad ( 6 )$$

The basic idea is to compare uncertainty caused by high-valued pixels and lowvalued pixels. In two adjacent exposures, this involves the cross-uncertainty of one and the cross-uncertainty of the next, except in the case of the first and last exposures, where we must use an absolute uncertainty caused by saturation in that given exposure alone.

These cross-linkages implement the cross-effects illustrated in FIG. 3D. A smooth and continuous control response is made possible by accounting for the floating-point difference in uncertainties, rather than simply incrementing and decrementing the exposure setting.

To complete the exposure control system, a exposure feedback response function controller 407 translates the delta-uncertainty signal to an exposure control signal. In one embodiment we used a PID (proportional integral derivative) control to govern the exposure change velocity, as follows:

$${v}_{e} ( t ) = {K}_{P} \cdot Δ {u}_{e} + {K}_{I} \cdot {\int }_{0}^{t} Δ {u}_{e} ( τ ) d τ + {K}_{D} \cdot \frac{d}{dt} Δ {u}_{e} \qquad ( 7 )$$

Finally, the exposure setting χₑ(t) is composed of the exposure control velocity νₑ, as:

χₑ(t)=∫₀^{t}νₑ(τ)dτ (8)

FIG. 4 illustrates an embodiment of the invention in which a lattice network of uncertainty calculators form the basis of the exposure control system. The array of exposure controllers 306 in FIG. 3D can be embodied as the calculators in FIG. 4, and are implemented, in one embodiment, as code running on a processor 212.

In FIG. 4, the physical phenomenon 301/401 is sensed by a plurality of sensor exposures 302/402, either embodied as multiple sensor transducers with controllable exposures, or one single sensor transducer with parallel signal conditioning lines which are separately controllable in terms of gain or other exposure quantities. Two or more sensor exposures 302 may be used; this illustration depicts an arbitrary number of sensor exposures numbered 1, 2, 3, . . . , E, represented by diagram elements 411, 412, 413, . . . , 419. The exposure 1 signal 421 describes the strongest dynamic levels of 401; the exposure 2 signal 422 describes the second-strongest dynamic levels of 401; and so on, until exposure E signal 429 which describes the weakest dynamic levels of 401. These two or more signals (e.g. 421 to 429) are optionally also connected into a processor and/or a dynamic range compositor 310.

An array of: supra-uncertainty calculators 403, infra-uncertainty calculators 404, cross-uncertainty calculators 405, delta-uncertainty calculators 406, and exposure feedback response function controllers 407 (such as PI or PID controllers) are implemented as either circuits, sequential code running on a processor 212, hardware on a programmable gate array, or the like. Supra-uncertainty signals 1, 2, 3, . . . , E are represented by 431 to 439. Infra-uncertainty signals 1, 2, 3, . . . , E are represented by 441 to 449. Cross-uncertainty signals 1, 2, 3, . . . , E−1 are represented by 451 to 458. Delta-uncertainty signals 1, 2, 3, . . . , E are represented by 461 to 469. Exposure control signals 1, 2, 3, . . . , E are represented by 471 to 479.

Salience Detection Subsystem, to Efficiently Control Exposures:

Rather than performing the above calculations on every single sensor reading (e.g. every pixel in an image), in other embodiments, only specific pixels, samples, or data are employed in the computation, to save on computation costs.

In one embodiment, the exposure control system is only fed data from a subset of the input data, at regular intervals such as every second, fourth, eighth, etc. pixel. This coverage zone is illustrated in FIG. 6B, as compared to the earlier embodiment with a uniform influence by all pixels in an image (FIG. 6A) These fixed intervals could permit relevant pixels to be skipped.

In another embodiment, the control system computes based on a subset of the most salient sensor readings (pixels). A saliency search system in included, which progressively evolves one or more zones in the image, which select the data which is fed into the exposure control system. These zones are progressively approached such that a histogram of the available data is optimized to contain increasingly relevant and representative data about each exposure's dynamic range. The salient zones can be computed in any zone of an image or sample data (illustrated in FIG. 6C), but the system is preferably designed to use rectangular, or otherwise regularized, salient zones, for increased computational efficiency. (illustrated in FIG. 6D).

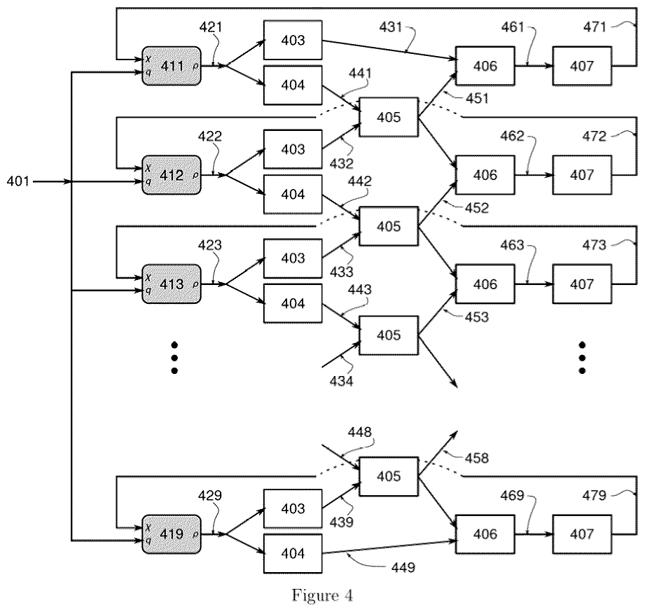

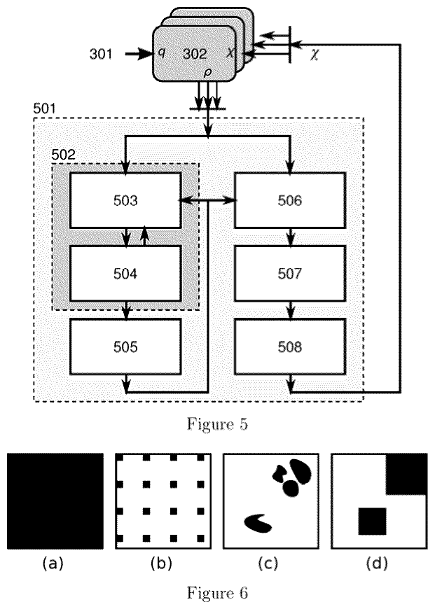

FIG. 5 illustrates an embodiment of the invention which consists also of a salience detection subsystem, in order to save on computation costs. The overall sensor controller is 501. A segmenter 506 extracts a subset of data from the total number of samples. This is fed into the same uncertainty 507 and control 508 subsystems as previously described to control the exposures. Meanwhile, on the left column of the figure, a parallel control system controls the choice of the subset of the exposures used by 506. One embodiment of this is as follows.

At each salient zone in the image, a trial run tester 502 contains latches to store a current segmented zone, and a searching dispatcher 503 to modify the zone size larger or smaller at each border, testing the improvement or worsening in a histogram cost function 504. This cost function places a penalty on histogram bins which are disproportionately empty in the final image. That is, if we lose relevant information in the salience zone, we gradually shift the salience zone to absorb regions where the composited image has an increasingly broad and diverse histogram. Finally, a control subsystem 505 affects the direction and/or rate of change of the salient zone.

By implementing this secondary control system, we enable real-time video-based HDR compositing, where the camera may move around over time, and the system tracks relevant features in the image—specifically relevant to measuring the dynamic range.

The ability to focus on highly salient regions of a video is especially relevant to HDR welding. Arc welding consists of a small volume of extremely bright light, surrounded by a large volume of relatively darker light. Traditionally welders use a mask which uniformly darkens the entire spatial field, which protects the eyes, but unfortunately prevents the welder from seeing the area around the torch, and even of finding the position of his or her hand.

Salience is relevant in HDR arc welding, due to the extreme segmentation of the image into a small number of pixels which are extremely bright, near the arc, and a large number of pixels which are darker. This situation lends itself well to isolation of the salient zone of the image and computational speed-up.

FIG. 6 illustrates examples of saliency segmentation of an image. Salience zones in an image or video: Reducing the computation to cover only a portion of the signal that is the most relevant for determining exposure control. (a) Illustrates the control of exposures based on the entire signal sample data. (b) A simple segmentation is to skip data at fixed intervals; unfortunately the constant nature of this data reduction may skip relevant samples that are saturated or cut off. (c) The most salient data includes samples which would influence the exposures to increase or decrease. Unfortunately, if we constantly re-compute exactly which samples are most relevant, we end up doing computation over the entire data set anyways, which defeats the purpose. (d) A segmentation scheme simplifies the exposure computation, and simplifies its own self-control computation.

Physical Analogy:

This exposure control system can be compared to a mass-spring system in physics. The exposure setting is analogous to the position of the mass, and the uncertainty cost functions are analogous to forces on the mass.

First we imagine one force controlling one mass: This is analogous to a single exposure, with only one factor controlling it, according to uncertainty in the image. If Δu(χ) were to behave linearly with the negative of χ, and if we only used the “I” term of the PID controller, the velocity control function ν(Δu) becomes:

νₑ(t)=K_{I}·∫₀^{t}Δuₑ(τ)dτ (9)

and therefore, the exposure setting is:

χₑ(t)=K_{I}·∫₀^{t}[∫₀^{t}Δuₑ(τ)dτ]dτ (10)

Therefore, the forcing function behaves according to Hooke's law, representing the physics of a spring: F=−k_{χ}. This would produce a simple harmonic motion, with 15 amplitude A, angular frequency ω, and phase ϕ:

χ(t)=A cos(ωt+ϕ) (11)

For two exposures, the equivalent mass-spring dynamics are:

$$\begin{matrix}m \frac{{d}^{2} {χ}_{1}}{{dt}^{2}} = - {k}_{{χ}_{1}} + k ( {χ}_{2} - {χ}_{1} ) & ( 12 ) \\ m \frac{{d}^{2} {χ}_{2}}{{dt}^{2}} = - {k}_{{χ}_{2}} + k ( {χ}_{1} - {χ}_{2} ) & ( 13 )\end{matrix}$$

This leads to two independent normal modes of oscillation:

$$\begin{matrix}{\vec{η}}_{A} = ( \begin{matrix}{χ}_{1}^{A} ( t ) \\ {χ}_{2}^{A} ( t )\end{matrix} ) = {c}_{A} ( \begin{matrix}1 \\ 1\end{matrix} ) cos ( {ω}_{A} t + {φ}_{A} ) & ( 14 ) \\ {\vec{η}}_{B} = ( \begin{matrix}{χ}_{1}^{B} ( t ) \\ {χ}_{2}^{B} ( t )\end{matrix} ) = {c}_{B} ( \begin{matrix}1 \\ - 1\end{matrix} ) cos ( {ω}_{B} t + {φ}_{B} ) & ( 15 )\end{matrix}$$

In this system, the PID coefficients are set to suppress sustained oscillation of the system (aided by the compressive nonlinearity of an image sensor).

FIG. 7 illustrates a physical analogy for coupled motion of the exposure controllers. A forcing function between each of the exposures can be imagined analogously to a series of pistons (bottom of diagram) providing a forcing function between a series of masses. The forcing functions are controlled by the uncertainty of the sensed signals, resulting from the choice of exposure settings at each point in time.

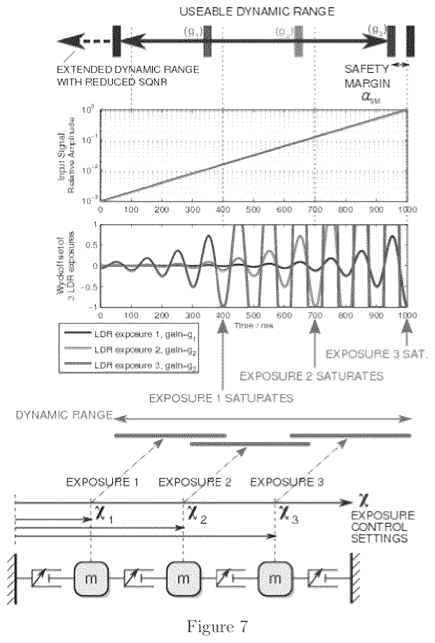

FIG. 8 illustrates a mass-spring analogy, for coupled motion of the exposure controllers. (a) Single mass-spring. (b) Analogy to a 3-exposure implementation of this system. (c) Analogy to a higher number of mass-springs. A perturbation on the masses can propagate through the series like a wave. This is analogous to a bright flash of light in the video stream, offsetting the HDR exposures until they re-adjust to optimize for the new conditions.

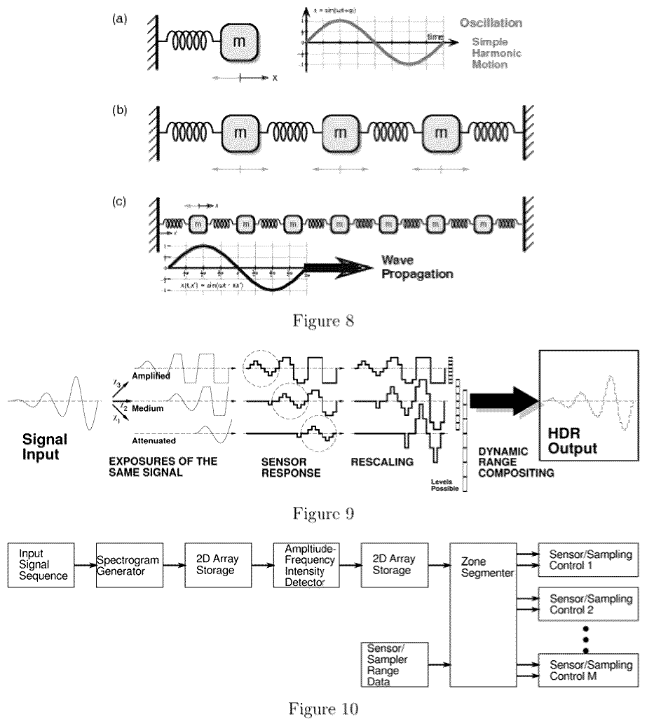

FIG. 9 illustrates HDR compositing, by way of example of a time-varying signal, acting on three exposures. When time-varying signals such as audio and images are composited, the compositing process must account for the scaling that was used to capture different exposures; account for any nonlinearity in the sensor (which can include compression functions (e.g. √(x), log(x)) and quantization); and account for the quality of information expressed in different portions of the dynamic range of each exposure. This latter function expresses the salience of each exposure's sensor reading, in the face of saturation, noise, and known nonlinearities in different parts of the sensor's dynamic range.

AF Segmentation, and AF Transformation:

In one embodiment of the invention, multiple sensors or sampling circuits are used with segmentation in both the frequency domain and the amplitude domain, to reduce the effect of strong signal components in one frequency range saturating (or cutting off) weak signal components in another frequency range (the “eclipse” phenomenon). Spectral filters are inserted in one or more of the parallel signal lines, such as before each amplifier 202 in FIG. 2C or 2D.

FIG. 10 illustrates an embodiment of the invention which includes a control system for the frequency parameters of the above filters. A sample input signal is fed into a spectrogram generator, whose 2D output is connected into an amplitude-frequency intensity detector. It operates by computing an “AF transform” on a signal. Rather than indicating one signal strength at each position or frequency, the AF transform is determined by taking a 2D joint histogram of the spectrogram [symbol] _{ƒ,n}{s(t)}, over values of frequency and intensity. The process is expressed as:

T^{AF}(A,ƒ){s(t)}= [symbol] dη where [symbol] = [symbol] _{ƒ,η}{s(t)} (16)

Finally, a zone segmenter divides off a number of zones in the A-F plane, by a cluster identification operation on the AF transform output. The resulting A-F zones are fed into the exposure control system (i.e. exposure gains and exposure frequency segmentation).

Further embodiments include an amplitude-frequency intensity detector alone, as described above. Further embodiments compute the harmonic range density function (HRDF), computationally-determined through harmonic analysis of the signal, converting by AF transform, and accumulating over each frequency in the spectral domain. The HRDF expresses the population of activity occurring at each amplitude for all frequencies.

Notes Regarding Sensors:

In various aspects of the present invention, references to “microphone” can mean any device or collection of devices capable of determining pressure, or changes in pressure, or flow, or changes in flow, in any medium, be it solid, liquid, or gas.

Likewise the term “geophone” describes any of a variety of pressure transducers, pressure sensors, velocity sensors, or flow sensors that convert changes in pressure or velocity or movement or compression and rarefaction in solid matter to electrical signals. Geophones may include differential pressure sensors, as well as absolute pressure sensors, strain gauges, flex sensors on solid surfaces like tabletops, and the like. Thus a geophone may have a single “listening” port or dual ports, one on each side of a glass or ceramic plate, stainless steel diaphragm, or the like, or may also include pressure sensors that respond only to discrete changes in pressure, such as a pressure switch which may be regarded as a 1-bit geophone. Moreover, the term “geophone” can also describe devices that only respond to changes in pressure or pressure difference, i.e. to devices that cannot convey a static pressure or static pressure differences. More particularly, the term “geophone” is used to describe pressure sensors that sense pressure or pressure changes in any frequency range whether or not the frequency range is within the range of human hearing, or subsonic (including all the way down to zero cycles per second) or ultrasonic.

Moreover, the term “geophone” is used to describe any kind of “contact microphone” or similar transducer that senses or can sense vibrations or pressure or pressure changes in solid matter. Thus the term “geophone” describes contact microphones that work in audible frequency ranges as well as other pressure sensors that work in any frequency range, not just audible frequencies. A geophone can sense sound vibrations in a tabletop, “scratching”, pressing downward pressure, weight on the table, i.e. “DC (Direct Current) offset”, as well as small-signal vibrations, i.e. AC (Alternating Current) signals.

### ADDITIONAL DESCRIPTION

The subject matter of the following research papers is incorporated by reference:
1. Ryan Janzen and Steve Mann (2017), “Extreme-Dynamic-Range Sensing: Real-Time Adaptation to Extreme Signals”, IEEE MultiMedia, 24(2), pp. 30-42.
2. Ryan Janzen and Steve Mann (2016), “Feedback Control System for Exposure Optimization in High-Dynamic-Range Multimedia Sensing”, Proc. IEEE ISM 2016, pp. 119-125.
3. Ryan Janzen and Steve Mann (2016), “The Physical-Fourier-Amplitude Domain, and Application to Sensing Sensors”, Proc. IEEE ISM 2016, pp. 317-320.

From the foregoing description, it will thus be evident that the present invention provides a design for feedback-based HDR sensing system for use as a sensory aid, data visualization system, measurement apparatus, diagnostic, recording system, or the like. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

What we claim as our invention is:

1. A device, apparatus or means consisting of at least one sensor (or at least one connection to at least one sensor), circuitry or other apparatus to derive from the sensor(s) two or more differently-exposed exposures, samplings, captures or gettings of the same physical phenomenon to be sensed, and circuitry or other apparatus connected in a feedback system configuration, to independently control the parameters of at least two of the exposures, samplings, captures or gettings.

2. A system as in (1) which generates one or more metrics or signals to describe the indeterminacy or efficacy of sensor readings across the dynamic range of the sampled signals.

3. A system as in (2) which generates the metrics from the sensor readings or sampled signals themselves.

4. A system as in (2) which generates the metrics from the physical phenomenon, beyond from information from the sampled signals themselves.

5. A system as in (1, 2 and/or 3) which controls the gain, exposure, ISO, aperture, and/or attenuation settings of a camera, audio sensor system, or other sensor system, in two or more exposures of the same subject matter.

6. A system as in (5) which controls the settings of one or more exposures based on opposing forcing functions which shift the exposure sensitivity higher or lower based on coverage of the physical phenomenon's dynamic range by two or more of the exposures.

7. A system which determines a salient subset of the total number of samplings of a physical phenomenon within one or more exposure output, where the subset is used to dynamically control exposure settings.

8. A system as in (7), where the salient subset is a subset of pixels within the total number of pixels in an image, or otherwise a spatial subset within a spatial array sampling of a physical phenomenon.

9. A system as in (7), where the salient subset is a subset of time-samples in a time-varying sequence, such as audio, within the total number of time-samples taken, or within the total number of time-samples within one frame of sampled data.

10. A system as in (7), where the salient subset is defined both in space, as in (8), as well as in time, as in (9), such as a subset of samples in video.

11. A system as in (7), where the salient subset has a fuzzy cardinality.

12. A system as in any of claims (1) to (11), in which multiple sensor readings are fed into a compositing subsystem which combines the information into an expanded dynamic range measurement or signal.

13. A system as in any of claims (1) to (12), in which one or more sensor output signals is/are fed into parallel frequency filters or other transformations, before ADC and/or before being HDR composited, in order to prevent or reduce eclipse phenomena in the HDR output.
